(19) United States
(12) Patent Application Publication
(10) Pub. No.: US 2015/0070308 A1
(43) Pub. Date: Mar. 12, 2015

(54) DISPLAY DEVICE WITH TOUCH DETECTION FUNCTION, ELECTRONIC APPARATUS PROVIDED WITH DISPLAY DEVICE, AND COVER MEMBER OF DISPLAY DEVICE

(71) Applicant: Japan Display Inc., Tokyo (JP)

(72) Inventors: Keiji TAKIZAWA, Tokyo (JP); Kazuyuki YAMADA, Tokyo (JP); Akio NAKAMURA, Tokyo (JP)

(21) Appl. No.: 14/478,215

(22) Filed: Sep. 5, 2014

(30) Foreign Application Priority Data
Sep. 10, 2013 (JP) 2013-187710

(51) Int. Cl. G06F 3/044

(52) U.S. Cl. CPC G06F 3/044
USPC 345/174

(57) ABSTRACT

A display device with touch detection function includes: a display panel including a display plane for displaying images and an electrostatic capacitance type touch detection device; a cover member stacked on the display plane of the display panel, the cover member having at least one recess portion and/or projection portion on the side of a touch surface opposite to a plane that faces the display panel; and a controller configured to send a signal upon the touch detection device detects a variance of electrostatic capacitance proximity to the at least one recess portion and/or projection portion.

### CROSS REFERENCES TO RELATED APPLICATIONS

The present application claims priority to Japanese Priority Patent Application JP 2013-187710 filed in the Japan Patent Office on Sep. 10, 2013, the entire content of which is hereby incorporated by reference.

### BACKGROUND

1. Field of the Invention

The present invention relates to a display device with touch detection function, an electronic apparatus provided with the display device, and a cover member of the display device.

2. Description of the Related Art

In recent years, there has been paid much attention to a touch detection device capable of detecting a target which may be an external object approaching the device itself. Such a touch detection device may be called a “touch panel” and the like. For example, the touch detection device may be used as a device to input information when combined with a display device to display various images for inputting the information. Thus, by combining such a touch detection device with such a display device, it becomes possible to input information without a conventional input device, for example, a keyboard, a mouse, a keypad and the like.

As a type of touch detection devices, there are known an optical type, a resistor type, an electrostatic capacity type and so on. An electrostatic capacity type of touch detection devices has a relatively simple structure and allows low power consumption. This type of touch detection devices may be used for mobile phones or mobile terminals. For example, Japanese Patent Application Laid-open Publication Nos. 2011-233018 and 2012-047807 describe an electrostatic capacity type of touch detection devices.

When information is input via an operation of a mechanical button, an operator/user can input the information while viewing the mechanical button. The operator/user can also input the information without viewing the mechanical button so long as he/she can feel the mechanical button via his/her finger. When information is input via an operation on a display plane of a display device with touch detection function, however, the operator/user may not easily input the information unless viewing the display plane. There is often the case where information should be input without viewing the display plane of the display device. Thus, there is a need for a display device with touch detection function allowing the operator/user to easily input information via an operation on a display plane of the display device without viewing the display plane.

In light of the foregoing, it is desirable to provide a display device with touch detection function that allows the user to facilitate information input operation even if the user cannot view a display plane.

### SUMMARY

According to an aspect of the present disclosure, a display device with touch detection function includes: a display panel including a display plane for displaying images and an electrostatic capacitance type touch detection device; a cover member stacked on the display plane of the display panel, the cover member having at least one recess portion and/or projection portion on the side of a touch surface opposite to a plane that faces the display panel; and a controller configured to send a signal upon the touch detection device detects a variance of electrostatic capacitance proximity to the at least one recess portion and/or projection portion.

According to another aspect of the present disclosure, an electronic apparatus includes the display device with touch detection function. The electronic apparatus of the present disclosure may be a television device and a mobile terminal device, such as a digital camera, a laptop computer, a video camera or mobile phone and so on.

Therefore, the display device with touch detection function 1 allows the user to facilitate information input operation on the display plane even if the user cannot view the display plane.

Additional features and advantages are described herein, and will be apparent from the following Detailed Description and the figures.

### BRIEF DESCRIPTION OF THE FIGURES

FIG. 1 is a schematic exploded view illustrating a display device with touch detection function according to an embodiment 1;

FIG. 2 is a schematic front view of a cover member according to the embodiment 1;

FIG. 3 is a schematic back view of a cover member according to the embodiment 1;

FIG. 4 is a A-A′ cross-sectional view of FIG. 1;

FIG. 5 is a A-A′ cross-sectional view of FIG. 1 when using a transparent film to provide a recess portion;

FIG. 6 is a schematic block diagram illustrating a relationship between a touch detection device and a controller;

FIG. 7 is a schematic exploded view illustrating a display device with touch detection function according to an embodiment 2;

FIG. 8 is a B-B′ cross-sectional view of FIG. 7;

FIG. 9 is a B-B′ cross-sectional view of FIG. 7 when using a transparent film to provide a projection portion;

FIG. 10 is a schematic perspective view of a cover member according to a modification 1;

FIG. 11 is a schematic perspective view of a cover member according to a modification 2;

FIG. 12 is a schematic perspective view of a cover member according to a modification 3; and

FIG. 13 is an exemplary view of an electronic apparatus to which a display device with touch detection function according to the embodiments and modifications is applied.

### DETAILED DESCRIPTION

Exemplary embodiments for implementing the present disclosure will be explained in detail below with reference to the accompanying drawings. The present disclosure is not limited by the contents described in the following embodiments. In addition, the components described as follows include those which can be easily conceived by persons skilled in the art and those which are substantially equivalent thereto. Moreover, the components described as follows can be arbitrarily combined with each other. The explanation is performed in the following order.

1. Embodiments (Display Device with Touch Detection Function)

1-1. Embodiment 1

1-2. Embodiment 2

2. Application Examples (Electronic Apparatus)

Examples of electronic apparatus to which the display device with touch detection function according to any of embodiments is applied.

3. Configuration of Present Disclosure

### 1. EMBODIMENTS

### Display Device with Touch Detection Function

### 1-1. Embodiment 1

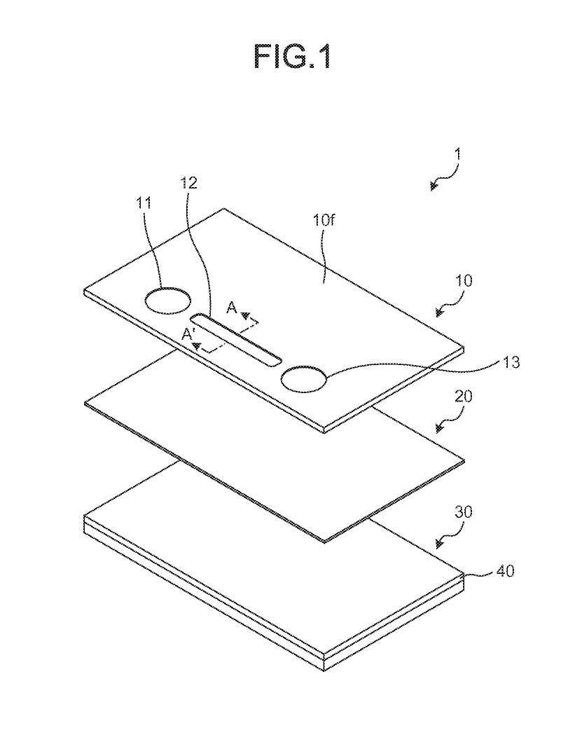

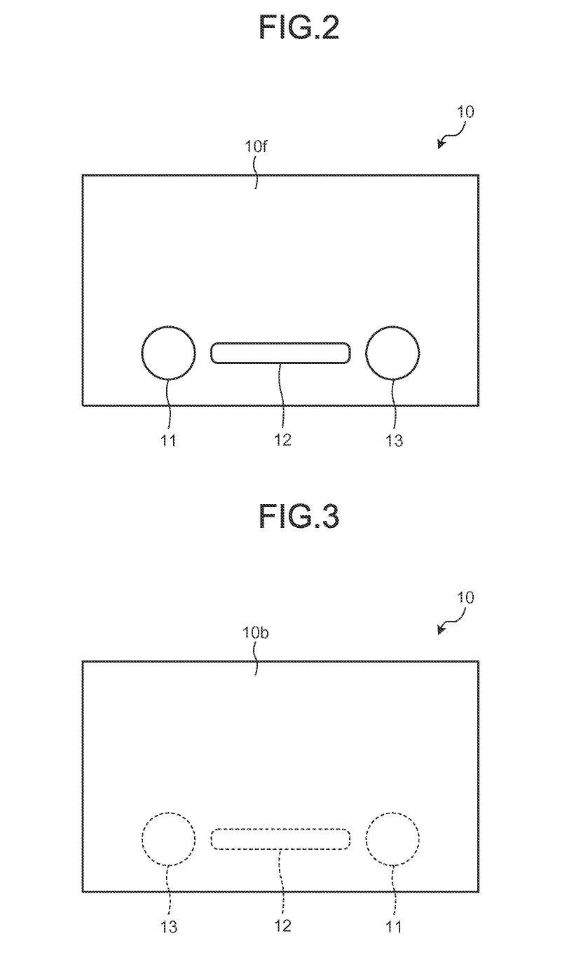

FIG. 1 is an exploded view illustrating a display device with touch detection function according to the embodiment 1. FIG. 2 is a front view illustrating a cover member of the display device according to the embodiment 1. FIG. 3 is a back view illustrating the cover member of the display device according to the embodiment 1. As illustrated in FIG. 1, a display device with touch detection function 1 includes a liquid crystal panel 30 as a display panel, a buffer layer 20, and a cover member 10. The display device with touch detection function 1 may include an organic EL (Electroluminescence) module instead of the liquid crystal panel 30.

The liquid crystal panel 30 includes a liquid crystal layer between two transparent substrates. The liquid crystal panel 30 according to the embodiment I is a FFS (Fringe Field Switching) type liquid crystal panel. One transparent substrate carries a drive electrode and pixel electrodes arranged in a matrix corresponding to pixels. The drive electrode and pixel electrodes are formed in a layered structure on the substrate. At least one of the two transparent substrates carries color filters such as R (Red) filter, G (Green) filter and B (Blue) filter arranged correspondingly to pixels. The liquid crystal panel 30 has openings formed on pixel electrodes or the drive electrode. An electric field leaked through openings (such an electric field is called “fringe electric field”) drives the liquid crystal of the liquid crystal layer. The liquid crystal panel 30 displays an image by switching a light transmission state and a light shutoff state at each pixel on the basis of image signals. The liquid crystal panel 30 may be of an IPS (In-plane Switching) type, a TN (Twisted Nematic) type, an OCB (Optically Compensated Bend or Optically Compensated Birefringence) type, or an ECB (Electrically Controlled Birefringence) type. The liquid crystal panel 30 may employ a normally black mode which displays black by shutting off light when supplied with no electric voltage. The liquid crystal panel 30 may employ a normally white mode which displays white by transmitting light when supplied with no electric voltage.

The liquid crystal panel 30 includes a touch detection device 40 which is of an electrostatic capacity type. For example, the touch detection device 40 may include a plurality of drive electrodes arranged in a plane, and a plurality of detection electrodes arranged in a plane different from the plane in which the plurality of drive electrodes arranged. The plurality of drive electrodes extend in a first direction, respectively, and aligned with each other in a second direction crossing the first direction. The plurality of touch detection electrodes extend in the second direction, respectively, and aligned with each other in the first direction. Each of the touch detection electrodes crosses the plurality of drive electrodes with a predetermined gap. In other words, each of the plurality of the touch detection electrodes crosses the plurality of drive electrodes with spaced apart respectively in a third direction perpendicular to both the first and the second directions. An electrostatic capacity arises at intersections where the drive electrodes cross the touch detection electrodes.

The touch detection device 40 includes a touch detection portion electrically connected to the touch detection electrodes. A variance in the electrostatic capacity arisen at a position where each of the drive electrodes cross the touch detection electrodes is input as a touch detection signal to the touch detection portion. From among positions where the drive electrodes cross the touch detection electrodes, the touch detection portion detects, on the basis of the touch detection signal, a position where the electrostatic capacity varies. On the basis of the touch detection signal, the touch detection portion identifies a position where the subject is in contact with or close to the touch detection device 40. Hereinafter, a situation or event where the subject is in contact with or close to the touch detection device 40 may be referred to as “touch” appropriately.

In the embodiment 1, a touch is detected on the basis of a variance in the electrostatic capacity at a position where a drive electrode crosses a touch detection electrode with spaced apart in the third direction and are opposed to each other. However, a position where any electrostatic capacity arises is not limited thereto. For example, the touch detection device 40 may detect a touch on the basis of an electrostatic capacitance arisen between a conductor extended from the drive electrodes and a conductor extended from the touch detection electrodes where both the conductors are aligned with each other on the same plane. That is, the touch detection device 40 may detect a touch on the basis of an electrostatic capacity arisen between a drive electrode and a touch detection electrode.

The buffer layer 20 is interposed between the liquid crystal panel 30 and the cover member 10. For example, the buffer layer 20 may be an optical elastic resin whose refractive index is the same as the refractive index of the cover member 10 and the same as the refractive index of the transparent substrate of a liquid crystal panel 30. Since the optical elastic resin has elasticity, the buffer layer 20 can alleviate an external impact and lower a risk of damage of the liquid crystal panel 30. Since the optical elastic resin has the refractive index the same as the refractive index of the cover member 10 and the refractive index of the liquid crystal panel 30, it is possible to reduce the light reflection at an interface between the cover member 10 and the optical elastic resin and an interface between the optical elastic resin and the liquid crystal panel 30. The buffer layer 20 may be an air gap. When the buffer layer 20 is made of the optical elastic resin, however, the refractive index of the buffer layer 20 can be the same as the refractive index of the cover member 10 and the refractive index of the liquid crystal panel 30. Therefore, it is preferable that the buffer layer 20 is made of the optical elastic resin. It is not necessary that the refractive index of the buffer layer 20 is the same as the refractive index of the cover member 10 and the refractive index of the liquid crystal panel 30. The buffer layer 20 may have a refractive index around the refractive index of the cover member 10 and the refractive index of the liquid crystal panel 30.

In the embodiment 1, for example, the optical elastic resin has characteristics that it is cured or hardened when heated. Accordingly, the characteristics, the liquid crystal panel 30 is adhered to the cover member 10 via the optical elastic resin by heating the optical elastic resin which is interposed between the liquid crystal panel 30 and the cover member 10. The optical elastic resin may have characteristics that it is cured or hardened when subjected to UV light.

The cover member 10 is stacked on a display plane (a plane for displaying an image) side of the liquid crystal panel 30 and protecting the display plane of the liquid crystal panel 30. For example, the cover member 10 may be made of glass and has a square shape when viewed from a vertical direction relative to the display plane. The cover member 10 has recess portions 11, 12, 13 on the side of the touch surface 10f which is opposed to a plane that faces the liquid crystal panel 30. Because the touch detection device 40 is of the electrostatic capacitive type, it is possible to detect that the object comes into touch or close to the touch surface 10f. For example, the object may be a finger of human-being. As illustrated in FIG. 3, the back plane is a plane that faces the liquid crystal panel 30 of the cover member 10, is flat and contacts with the buffer layer 20. The cover member 10 can protect a surface of the liquid crystal panel 30. The material of the cover member 10 may include various materials with transparent characteristics, such a transparent resin. The cover member 10 may have squire or circular shape when viewed from a vertical direction relative to the display plane.

As illustrated in FIG. 3, when viewed from a vertical direction relative to the touch surface 10f, the recess portions 11, 13 of the embodiment 1 has a circle shape, and the recess portion 12 has substantial rectangular shape. In the following, shape viewed from a vertical direction relative to the touch surface 10f simply refers to as a “2-dimensional shape.” The recess portion 12 is located between the recess portions 11 and 13. The direction of a longitudinal side of the recess portion 12 is parallel to a direction of a linear line passing centers of the recess portions 11, 13. The recess portions 11, 12 and 13 may be located along the longitudinal side of the cover member 10 as well as located closer to the longitudinal side of the touch surface 10f than a center thereof.

Arrangement of the recess portions 12 and 13 are not limited thereto. For example, recess portions 11, 12 and 13 may be located along a traverse side of the cover member 10. Alternatively, the recess portions 11, 12 and 13 may be located at the center of the touch surface 10f. It is, however, preferable that the recess portions are located close to the longitudinal or traverse side away from the center of the touch surface 10f because the recess portions 11, 12 and 13 are less vivid desirably. The cover member 10 may include the recess portions 11, 12 and 13. For example, one of the recess portions 11, 12 and 13, or combination of two of the recess portions 11, 12 and 13 may be formed on the cover member 10.

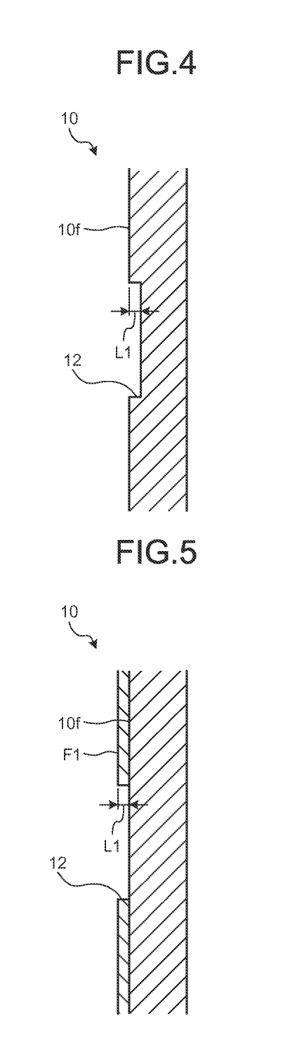

FIG. 4 illustrates a A-A′ cross-sectional view of FIG. 1. As illustrated in FIG. 4, the recess portion 12 may be a groove with a dimension L1 in depth. Thereby, the user can recognize the position of the recess portion 12 by touching the edge of the recess portion 12. For example, the recess portion 12 is formed by ablating the touch surface 10f. For example, dimension L1 may be 0.1 mm. It is preferable that dimension L1 is from 0.02 mm to 0.5 mm. In the case where dimension L1 is greater than 0.02 mm, the cover member 10 improves the possibility that the human being can recognize the recess portion with his/her sense of finger. In the case where dimension L1 is not more than 0.5 mm, the cover member 10 decreases the possibility that the recess portion 12 interferes with a visibility of the image displayed via the liquid crystal panel 30. Although the recess portion 12 has been described above, the same description may be also applied to other recess portions 11 and 13. Thus, the display device with touch detection function 1 allows the user to recognize each position of the recess portions 11, 12 and 13 by touching the recess portions 11, 12 and 13 without viewing the display plane of the liquid crystal panel 30.

Although the recess portions 11, 12 and 13 according to the embodiment 1 are formed by ablating the touch surface 10f, the recess portions 11, 12 and 13 may be provided by transparent film. FIG. 5 illustrates A-A′ cross-sectional view of FIG. 1 where the recess portions are formed with transparent film. In this case, a transparent film F1 includes substantially rectangular through hole. The through hole overlaps a part of the touch surface 10f. Side wall of the recess portion 12 configures a cross-section of the through hole as well as a cross-section of the transparent film F1. For example, the transparent film F1 may be made of polyethylene terephthalate and the like, function as an anti-scattering film with dimension L1 in thickness. The transparent film F1 allows the user to recognize the position of the recess portion 12 by touching the edge of the recess portion 12 of the transparent film F1. The transparent film F1 includes two of circular through holes. The side wall of the recess portion 11 configures cross section of one through hole of the two of circular through holes. The side wall of the recess portion 13 configures cross section of the other through hole of the two of circular through holes. Thus, the display device with touch detection function 1 allows the user to recognize each position of the recess portions 11, 12 and 13 by touching the recess portions 11, 12 and 13 without viewing the display plane of the liquid crystal panel 30. The transparent film F1 can provide the display device with touch detection function 1 with recession portions 11, 12 and 13 much easier than ablating the touch surface 10f. The side wall of the recess portions 11, 12 and 13 may include at least part of cross section of the transparent film F1. For example, one part of side wall of the recess portions 11, 12, 13 may be configured by cross section of the transparent film F1, and the other part of side wall of the recess portions 11, 12, 13 may be configured by a housing and the like which encloses the display device with touch detection function 1.

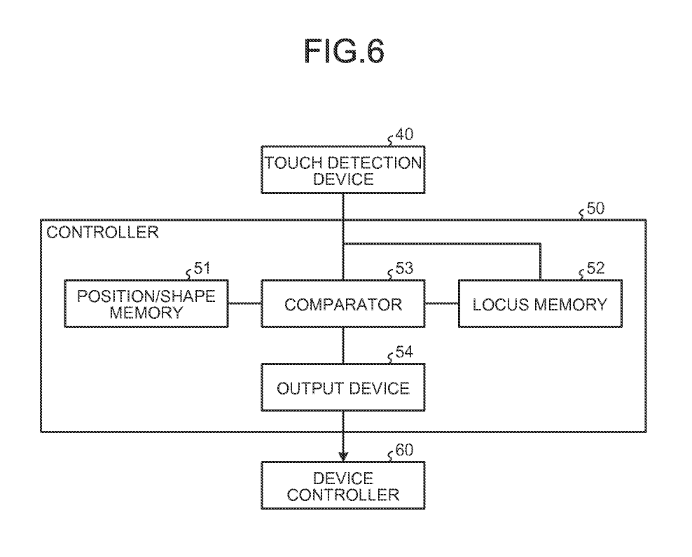

FIG. 6 is a block diagram illustrating a relationship between a touch detection device and a controller. The display device with touch detection function 1 includes a controller 50 which is connected to a touch detection device 40. The electrostatic capacitance of a portion where the user brings his/her finger into touch or close to the touch surface 10f varies. When the touch detection device 40 detects the variance of the electrostatic capacitance proximate to either the recess portions 11, 12 and 13, the controller 50 can output a signal in accordance with input function assigned to the recess portion. Furthermore, the controller 50 can change an output signal according to locus of a position where the touch detection device 40 detects the variance of electrostatic capacitance. Furthermore, when the touch detection device 40 detects the variance of the electrostatic capacitance proximate to neither the recess portions 11, 12 and 13, the controller 50 does not output a signal according to input function assigned to each of the recess portions. The position proximate to the recess portion is defined as a portion of the touch detection device 40, which corresponds to an edge of the recess portion, an inner portion from the edge of the recess portion or an outer peripheral portion of the edge of the recess portion.

The controller 50 includes a position/shape memory 51, a locus memory 52, a comparator 53 and an output device 54, and is connected to both a touch detection device 40 and a device controller 60. The controller 50, for example, may be a microcomputer including CPU (Central Processing Unit), ROM (Read Only Memory), RAM (Random Access Memory), and I/O interface circuit (Input/output device). The position/shape memory 51 can store, for example, information associated with a position and 2-dimensional shape of each of the recess portions 11, 12 and 13 in accordance with information stored in the RAM as a memory. The locus memory 52 is a function which is realized by the CPU, ROM and RAM, and stores, for example in RAM as a memory, locus of a position where the touch detection device 40 detects the variance of electrostatic capacitance, which is calculated with the CPU. The comparator 53 is a function which is realized by the CPU, ROM and RAM, and compares information of a position where the touch detection device 40 detects the variance of electrostatic capacitance and information stored in the position/shape memory 51. Furthermore, the comparator 53 compares information stored in the locus memory 52 and information associated with a position and 2-dimensional shape of each of the recess portions 11, 12 and 13, which is stored in the position/shape memory 51. The output device 54 is a function which is realized by the CPU, ROM, RAM and I/O interface circuit, send a signal in response to the result of comparison to a device controller 60.

For example, the controller 50 captures information of a position where the touch detection device 40 detects the variance of electrostatic capacitance in a periodic manner of a predetermined time interval. The comparator 53 compares a position where the touch detection device 40 detects the variance of electrostatic capacitance and a position of recess portions 11, 12, 13 stored in the position/shape memory 51. As a result of the comparison, if the touch detection device 40 has detected a variance of electrostatic capacitance proximate to either the recess portions 11, 12 or 13, the comparator 53 causes the output device 54 to output a signal. The output device 54 sends to a device controller 60 a signal which controls an operation of the liquid crystal panel 30. For example, upon receiving a signal from the output device 54, the device controller 60 takes the liquid crystal panel 30 into the state awaiting for change of the signal.

The locus memory 52 calculates locus of a position where the touch detection device 40 has detected the variance of electrostatic capacitance on the basis of information received from the touch detection device 40 and stores the locus in itself. The locus of a position where the touch detection device 40 has detected the variance of electrostatic capacitance based on information received from the touch detection device 40 is, for example, a representative of finger movement on the touch surface 10f. Furthermore, the locus memory 52 calculates a moving rate and a moving direction of a position where the touch detection device 40 has detected the variance of electrostatic capacitance on the basis of information received from the touch detection device 40 and time when the information has been received therefrom, and stores the results in itself. If the comparator 53 makes a determination that the detection device 40 has detected a variance of electrostatic capacitance proximate to either the recess portions 11, 12 or 13, the comparator 53 compares 1) locus of a position, stored in the locus memory 52, where the touch detection device 40 has detected the variance of electrostatic capacitance and 2) 2-dimensional shape of the recess portion that is the closest to the position where the touch detection device 40 has detected the variance of electrostatic capacitance among the recess portions 11, 12 and 13, which is stored in the position/shape memory 51. As a result of the comparison, if the locus tracks the 2-dimension shape, the comparator 53 changes a signal output from the output device 54 in accordance with a moving rate and a moving direction of a position, stored in the locus memory 52, where the touch detection device 40 has detected the variance of electrostatic capacitance. In this way, the controller 50 changes a signal output from the output device 54 in accordance with the locus of a position where the touch detection device 40 has detected the variance of electrostatic capacitance. The device controller 60 controls the liquid crystal panel 30 in accordance with a change of the signal output from the output device 54. The subjective device to be controlled by the device controller 60 may be an external device such as an audio component set or an air conditioner and the like.

The device controller 60 controls the liquid crystal panel 30 to zoom in or zoom out the display image in accordance with variation of the signal output from the output device 54, for example. The device controller 60 may control the liquid crystal panel 30 to adjust luminance of the display device or scroll displayed image in accordance with the change of the signal output from the output device 54. The device controller 60 may control an external device such as the audio component set to adjust a volume of the audio and/or select a tune in accordance with the change of the signal output from the output device 54. The device controller 60 may control an external device such as the air conditioner to adjust preset temperature and/or air flow rate thereof in accordance with a change of the signal output from the output device 54. Upon the detection device 40 has detected a variance of electrostatic capacitance proximate to either the recess portions 11, 12 or 13, the device controller 60 may control the liquid crystal panel 30 to display several types of images for input on the liquid crystal panel 30, which correspond to the recess portions 11, 12 and 13.

As described above, 2-dimensional shape of the recess portion 11 is circle. When the user brings his/her finger into touch or close to the touch surface 10f, the detection device 40 detects a position where electrostatic capacitance varies. The comparator 53 compares a position where the touch detection device 40 has detected the variance of electrostatic capacitance and a position of each of the recess portions 11, 12 and 13 stored in the position/shape memory 51. For example, when the user brings his/her finger into touch or close to the recess portion 11, as a result of the comparison, the comparator 53 makes a determination that the touch detection device 40 has detected the variance of electrostatic capacitance proximity to the recess portion 11. Then, followed by moving the finger along the edge of the recess portion 11, the locus memory 52 calculates locus of a position where the touch detection device 40 has detected the change of electrostatic capacitance on the basis of information received from the touch detection device 40, and stores the circle like locus in itself. Furthermore, the locus memory 52 calculates a moving rate and a moving direction of a position where the touch detection device 40 has detected the variance of electrostatic capacitance on the basis of information received from the touch detection device 40 and time when the information has been received therefrom, and stores the results in itself. If the comparator 53 makes a determination that the detection device 40 has detected a variance of electrostatic capacitance proximate to recess portion 11, the comparator 53 compares the circular locus stored in the locus memory 52 and 2-dimensional shape of the recess portion 11 stored in the position/shape memory 51. As a result of the comparison, because the finger moves along the edge of recess portion 11, the comparator 53 makes a determination that the circular locus tracks the 2-dimensional shape of recess portion 11. Then, the comparator 53 changes a signal output from the output device 54 in accordance with a moving rate and a moving direction of a position where the touch detection device 40 has detected the variance of electrostatic capacitance. In this way, the controller 50 changes a signal output from the output device 54 in accordance with the locus of a position where the touch detection device 40 has detected the variance of electrostatic capacitance. The device controller 60 controls the liquid crystal panel 30 to adjust luminance of the display device in accordance with change of the signal output from the output device 54.

The subject to be changed by the device controller 60 is not limited to the luminance of the display.

As described above, 2-dimensional shape of the recess portion 12 is substantial rectangle. When the user brings his/her finger into touch or close to the touch surface 10f, the detection device 40 detects a position where electrostatic capacitance varies. The comparator 53 compares a position where the touch detection device 40 has detected the variance of electrostatic capacitance and a position of each of recess portions 11, 12 and 13 stored in the position/shape memory 51. For example, when the user brings his/her finger into touch or close to the recess portion 12, as a result of the comparison, the comparator 53 makes a determination that the touch detection device 40 has detected the variance of electrostatic capacitance proximity to the recess portion 12. Then, followed by moving the finger along the edge of the recess portion 12, the locus memory 52 calculates locus of a position where the touch detection device 40 has detected the variance of electrostatic capacitance on the basis of information received from the touch detection device 40, and stores the circle like locus in itself. Furthermore, the locus memory 52 calculates a moving rate and a moving direction of a position where the touch detection device 40 has detected the variance of electrostatic capacitance on the basis of information received from the touch detection device 40 and time when the information has been received therefrom, and stores the results in itself. If the comparator 53 makes a determination that the detection device 40 has detected a variance of electrostatic capacitance proximate to recess portion 12, the comparator 53 compares the circular locus stored in the locus memory 52 and the 2-dimensional shape of the recess portion 12 stored in the position/shape memory 51. As a result of the comparison, because the finger moves along the edge of recess portion 12, the comparator 53 makes a determination that the circular locus tracks the 2-dimensional shape of recess portion 12. Then, the comparator 53 changes a signal output from the output device 54 in accordance with a moving rate and a moving direction of a position where the touch detection device 40 has detected the variance of electrostatic capacitance. In this way, the controller 50 changes a signal output from the output device 54 in accordance with locus of a position where the touch detection device 40 has detected the variance of electrostatic capacitance. The device controller 60 controls the liquid crystal panel 30 to scroll the display image in accordance with a change of the signal output from the output device 54.

The subject to be changed by the device controller 60 is not limited to the scroll of the displayed image.

As described above, the 2-dimensional shape of the recess portion 13 is circle. When the user brings his/her finger into touch or close to the touch surface 10f, the detection device 40 detects a position where electrostatic capacitance varies. The comparator 53 compares a position where the touch detection device 40 has detected the variance of electrostatic capacitance and a position of each the recess portions 11, 12 and 13 stored in the position/shape memory 51. For example, when the user brings his/her finger into touch or close to the recess portion 13, as a result of the comparison, the comparator 53 makes a determination that the touch detection device 40 has detected the variance of electrostatic capacitance proximity to the recess portion 13. Then, followed by moving the finger along the edge of the recess portion 13, the locus memory 52 calculates locus of a position where the touch detection device 40 has detected the variance of electrostatic capacitance on the basis of information received from the touch detection device 40, and stores the circle like locus in itself. Furthermore, the locus memory 52 calculates a moving rate and a moving direction of a position where the touch detection device 40 has detected the variance of electrostatic capacitance on the basis of information received from the touch detection device 40 and time when the information has been received therefrom, and stores the results in itself. If comparator 53 makes a determination that the detection device 40 has detected a variance of electrostatic capacitance proximate to the recess portion 13, the comparator 53 compares the circular locus stored in the locus memory 52 and the 2-dimensional shape of the recess portion 13 stored in the position/shape memory 51. As a result of the comparison, because the finger moves along the edge of the recess portion 13, the comparator 53 makes a determination that the circular locus tracks the 2-dimensional shape of the recess portion 13. Then, the comparator 53 changes a signal output from the output device 54 in accordance with a moving rate and a moving direction of a position where the touch detection device 40 has detected the variance of electrostatic capacitance. In this way, the controller 50 changes the signal output from the output device 54 in accordance with the locus of a position where the touch detection device 40 has detected the variance of electrostatic capacitance. The device controller 60 controls the audio component set to adjust a volume in accordance with a change of the signal output from the output device 54. The subject to be changed by the device controller 60 when the user moves his/her finger along the edge of the recess portion 13 is not limited to the volume of the audio component set. The subject to be changed by the device controller 60 when the user moves his/her finger along the edge of the recess portion 13 may be the same as the subject to be changed by the device controller 60 when the user moves his/her finger along the edge of the recess portion 11.

In this way, when the user moves his/her finger along the recess portion, the display device with touch detection function 1 can assign functions for input to each the recess portions 11, 12, 13. Furthermore, when the user moves his/her finger along the edge of either recess portions 11, 12 or 13, the subject to be changed by the device controller 60 is a subject which is easy for the user to associate with the 2-dimensional shape of the recess portion.

Thus, the display device with touch detection function 1 enables the user to input information by bringing his/her finger into touch to the recess portions 11, 12, 13 on the display plane. Furthermore, the display device with touch detection function 1 enables the user to recognize a position of the recess portions 11, 12, 13 through his/her touch sense even if the user cannot view the recess portions 11, 12, 13. Therefore, the display device with touch detection function 1 allows the user to facilitate information input operation on the display plane even if the user cannot view the display plane.

Furthermore, because the controller 50 allows the output device 54 to output a signal which is changed in accordance with the locus of a position where the touch detection device 40 has detected a variance of electrostatic capacitance, the display device with touch detection function 1 enables the user to input information in accordance with movement of user's finger. Accordingly, when the user moves his/her finger along the edge of either the recess portions 11, 12 or 13, the subject to be changed by the device controller 60 is a subject which is easy for the user to associate with the 2-dimensional shape of the recess portion. Therefore, the display device with touch detection function 1 allows the user to facilitate information input operation on the display plane even if the user cannot view the display plane.

Moreover, the display device with touch detection function 1 includes a buffer layer 20 that is made of optical elastic resin, which is interposed between the liquid crystal panel 30 and the cover member 10. This results in decrease of reflection at an interface between the cover member 10 and the optical elastic resin and at an interface between the optical elastic resin and the liquid crystal panel 30. As the decrease of reflection at the interface, the recess portions 11, 12 and 13 are less vivid. Thus, the display device with touch detection function 1 decreases possibility that the recess portions 11, 12, 13 interfere visibility of the display image.

Preferably, the touch surface 10f of the cover member 10 is unti-glare treated. Advantageously, it leads to decrease of possibility that glare on the touch surface 10 occurs due to scattering of light incident on the touch surface 10f. As the decrease of possibility that glare occurs, the recess portions 11, 12 and 13 are less vivid. Thus, the display device with touch detection function 1 decreases possibility that the recess portions 11, 12, 13 interfere visibility of the display image.

Preferably, the touch surface 10f of the cover member 10 is unti-reflection treated. Advantageously, it leads to decrease of reflectivity of light on the touch surface 10f. As the decrease of reflectivity of light on the touch surface 10f, the recess portions 11, 12 and 13 are less vivid. Thus, the display device with touch detection function 1 decreases possibility that recess portions 11, 12, 13 interfere visibility of the display image.

Preferably, the touch surface 10f of the cover member 10 is treated with a water-shedding coating or an oil-shedding coating. Advantageously, it leads to less vivid of a finger print or other dust adhered on the touch surface 10f as well as to easy wipe off the touch surface 10f. As less vivid of the finger print adhered near the recess portions 11, 12 and 13 and easy wipe off, the recess portions 11, 12 and 13 are less vivid. Thus, the display device with touch detection function 1 decreases possibility that recess portions 11, 12 and 13 interfere with a visibility of the display image.

Preferably, the touch surface 10f of the cover member 10 is treated with a hydrophilic coating or a lipophilic coating. Advantageously, it leads to less vivid of the finger print or other dust adhered on the touch surface 10f because the finger print thinly spreads over the touch surface 10f. As less vivid of finger print adhered near the recess portions 11, 12 and 13, the recess portions 11, 12 and 13 are less vivid. Thus, the display device with touch detection function 1 decreases possibility that the recess portions 11, 12 and 13 interfere visibility of the display image.

### 1-2. Embodiment 2

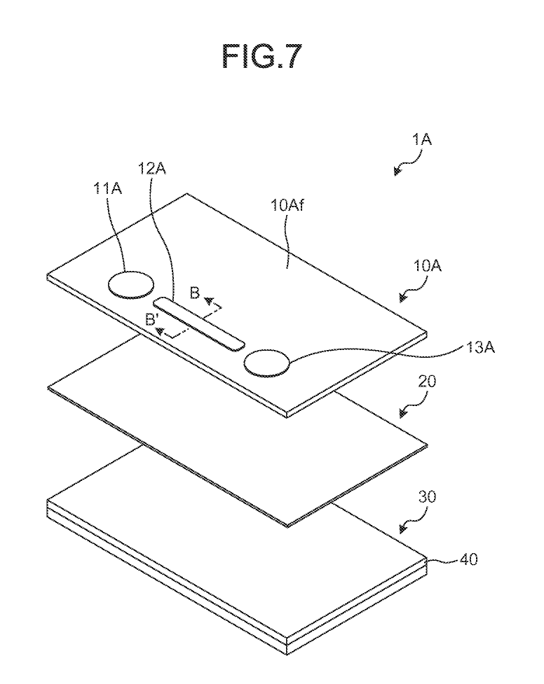

FIG. 7 is an exploded view illustrating a display device with touch detection function according to the embodiment 2. As illustrated in FIG. 7, a display device with touch detection function 1A includes a liquid crystal panel 30 as a display panel, a buffer layer 20, and a cover member 10A. Elements substantially identical in function and configuration as those of the embodiment 1 are denoted by like reference numerals, and points where the modification differs from the embodiment 1 are mainly described below.

The cover member 10A is a component stacked on a display plane side of the liquid crystal panel 30 and protecting the display plane of the liquid crystal panel 30. For example, the cover member 10A may be made of glass and has a rectangle shape when viewed from a vertical direction relative to the display plane. The cover member 10A has projection portions 11A, 12A and 13A on the side of the touch surface 10Af which is opposite to a plane that faces the liquid crystal panel 30. The back plane which faces the liquid crystal panel 30 of the cover member 10A, is flat and contacts with the buffer layer 20. The cover member 10A can protect a surface of the liquid crystal panel 30. The material of the cover member 10A may include various materials with transparent characteristics, such as a transparent resin. Alternatively, the cover member 10A may have a squire or circular shape when viewed from a vertical direction relative to the display plane.

As illustrated in FIG. 7, each of the projection portions 11A, 13A of the embodiment 2 has 2-dimensional circle shape, and the projection portion 12A has substantial rectangular shape. The projection portion 12A is located between the projection portions 11A and 13A. The direction of a longitudinal side of the projection portion 12A is parallel to a direction of a linear line passing centers of the projection portions 11A, 13A. The projection portions 11A, 12A and 13A may be located along the longitudinal side of the cover member 10A as well as closer to the longitudinal side of the touch surface 10Af than a center thereof.

Arrangement of the projection portions 11A, 12A and 13A are not limited thereto. For example, the projection portions 11A, 12A and 13A may be located along a traverse side of the cover member 10A. Alternatively, the projection portions 11A, 12A and 13A may be located in line at the center of the touch surface 10Af. It is, however, preferable that the projection portions 11A, 12A, 13A are located close to the longitudinal or traverse side away from the center of the touch surface 10Af because the projection portions 11A, 12A and 13A are less vivid. The cover member 10A may not include all of the projection portions 11A, 12A and 13A. For example, the cover member 10A may include one of the projection portions 11A, 12A and 13A, or combination of two of the projection portions 11A, 12A and 13A.

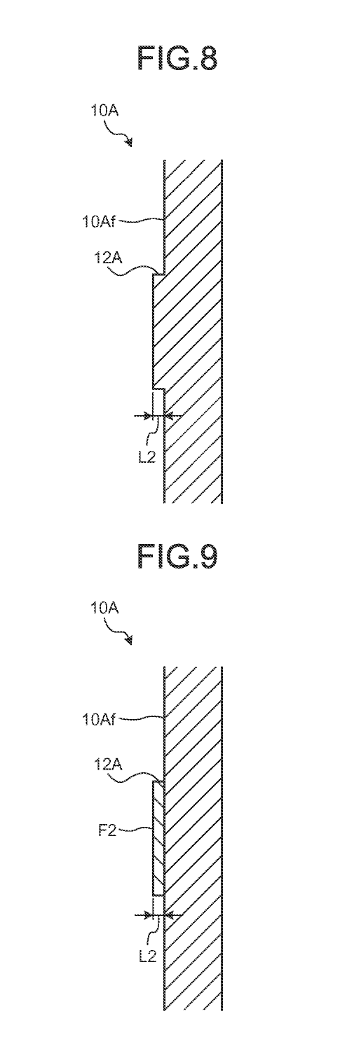

FIG. 8 illustrates a A-A′ cross-sectional view of FIG. 7. As illustrated in FIG. 8, the projection portion 12A may be a bump with a dimension L2 in height. Thereby, the user can easily recognize the position of the projection portion 12A by touching the edge of the projection portion 12A. For example, the projection portion 12A is formed by ablating the touch surface 10Af except for the projection portion 12A. For example, the dimension L2 according to the embodiment 2 may be 0.1 mm. It is preferable that the dimension L2 is from 0.02 mm to 0.5 mm. In the case where the dimension L2 is greater than 0.02 mm, cover member 10A improves the possibility that the human being can recognize the projection portion with his/her sense of a finger. In the case where the dimension L2 is not more than 0.5 mm, the cover member 10A decreases the possibility that the projection portion interferes with a visibility of the image displayed on the liquid crystal panel 30. Although the projection portion 12A has been described above, the same description may be also applied to other projection portions 11A and 13A. Thus, the display device with touch detection function 1A allows the user to easily recognize each position of the projection portions 11A, 12A and 13A by touching the projection portions 11A, 12A and 13A without viewing the display plane of the liquid crystal panel 30.

Although the projection portions 11A, 12A and 13A according to the embodiment 2 are formed by ablating the touch surface 10Af except for the projection portions 11A, 12A and 13A, the projection portions 11A, 12A and 13A may be formed with a transparent film. FIG. 9 illustrates A-A′ cross-sectional view of FIG. 7 where the projection portions are formed with the transparent film. In this example, the transparent film F2 may have a substantially rectangular shape, and be stacked on a part of the touch surface 10Af. Side wall of the recess portion 12A configures a cross-section of the transparent film F2. For example, the transparent film F2 may be made of polyethylene terephthalate and the like, and function as an anti-scattering film with dimension L2 in thickness. The transparent film F2 allows the user to easily recognize the position of the projection portion 12A by touching the edge of the projection portion 12A. In addition to the transparent film F2, two of circular transparent films are stacked on a part of the touch surface 10Af. The side wall of the projection portion 11A configures cross section of one of the two of circular transparent films. The side wall of the projection portion 13A configures cross section of the other of the two of circular transparent films. Thus, the display device with touch detection function 1A allows the user to recognize each position of the projection portions 11A, 12A and 13A by touching the projection portions 11A, 12A and 13A without viewing the display plane of the liquid crystal panel 30. Transparent film F1 can provide the display device with touch detection function 1A with projection portions 11A, 12A and 13A much easier than ablating the touch surface 10Af. The side wall of the projection portions 11A, 12A and 13A may include at least part of cross section of the transparent film F2. For example, one part of the side wall of the projection portions 11A, 12A and 13A may be configured by cross section of the transparent film F2, and the other part of the side wall of the projection portions 11A, 12A and 13A may be configured by a housing and the like which encloses the display device with touch detection function 1A.

The display device with touch detection function 1A includes a controller 50 that is connected to the touch detection device 40 illustrated in FIG. 6. As described above, the 2-dimension shape of the projection portion 11A is circle. When the user moves his/her finger along the edge of the projection portion 11A, the device controller 60 controls the liquid crystal panel 30 to adjust luminance of the display device in accordance with a change of the signal output from the output device 54. The subject to be changed by the device controller 60, when the user moves his/her finger along the edge of the projection portion 11A, is not limited to the luminance of the display.

As described above, 2-dimensional shape of the projection portion 12A is substantially rectangular. When the user moves his/her finger along the longitudinal side of the projection portion 12A, the device controller 60 controls the liquid crystal panel 30 to scroll the displayed image in accordance with a change of the signal output from the output device 54. The subject to be changed by the device controller 60, when the user moves his/her finger along the longitudinal side of the projection portion 12A, is not limited to the scroll of the displayed image.

As described above, the 2-dimensional shape of the projection portion 13A is circle. When the user moves his/her finger along the edge of the projection portion 13A, the device controller 60 controls an audio component set to adjust a volume in accordance with a change of the signal output from the output device 54. The subject to be changed by the device controller 60, when the user moves his/her finger along the edge of the projection portion 13A, is not limited to the volume of the audio component set. The subject to be changed by the device controller 60 when the user moves his/her finger along the edge of the projection portion 13A may be the same as the subject to be changed by the device controller 60 when the user moves his/her finger along the edge of the projection portion 11A.

In this way, when the user moves his/her finger along either the projection portions 11A, 12A or 13A, the display device with touch detection function 1A can assign functions for input to each the projection portions 11A, 12A and 13A. Furthermore, when the user moves his/her finger along the edge of either the projection portions 11A, 12A or 13A, the subject to be changed by the device controller 60 is a subject which is easy for the user to associate with the 2-dimensional shape of the projection portion.

Preferably, the touch surface 10Af of the cover member 10A is unti-glare treated. Advantageously, it leads to decrease of possibility that glare on the touch surface 10Af occurs due to scattering of light incident on the touch surface 10Af. As the decrease of possibility that the glare occurs, the projection portions 11A, 12A and 13A are less vivid. Thus, the cover member 10A decreases possibility that projection portions 11A, 12A and 13A interfere with a visibility of images displayed on the liquid crystal panel 30.

Preferably, the touch surface 10Af of the cover member 10A is unti-reflection treated. Advantageously, it leads to decrease of reflectivity of light on the touch surface 10Af. As decrease of reflectivity of light on the touch surface 10Af, the projection portions 11A, 12A and 13A are less vivid. Thus, the cover member 10A decreases possibility that projection portions 11A, 12A, 13A interfere with a visibility of the displayed image on the liquid crystal panel 30.

Preferably, the touch surface 10Af of the cover member 10A is treated with a water-shedding coating or an oil-shedding coating. Advantageously, it leads to less vivid of finger print or other dust adhered on the touch surface 10Af as well as to easy wipe off the touch surface 10Af. As less vivid of a finger print adhered near the projection portions 11A, 12A and 13A and easy wipe off, the projection portions 11A, 12A and 13A are less vivid. Thus, the cover member 10A decreases possibility that the projection portions 11A, 12A and 13A interfere with a visibility of images displayed on the liquid crystal panel 30.

Preferably, the touch surface 10Af of the cover member 10A is treated with a hydrophilic coating or a lipophilic coating. Advantageously, it leads to less vivid of a finger print or other dust adhered on the touch surface 10Af because the finger print thinly spreads over the touch surface 10Af. As less vivid of the finger print adhered near the projection portions 11A, 12A and 13A, the projection portions 11A, 12A and 13A are less vivid. Thus, the cover member 10A decreases possibility that projection portions 11A, 12A and 13A interfere with a visibility of images displayed on the liquid crystal panel 30.

[Modification 1]

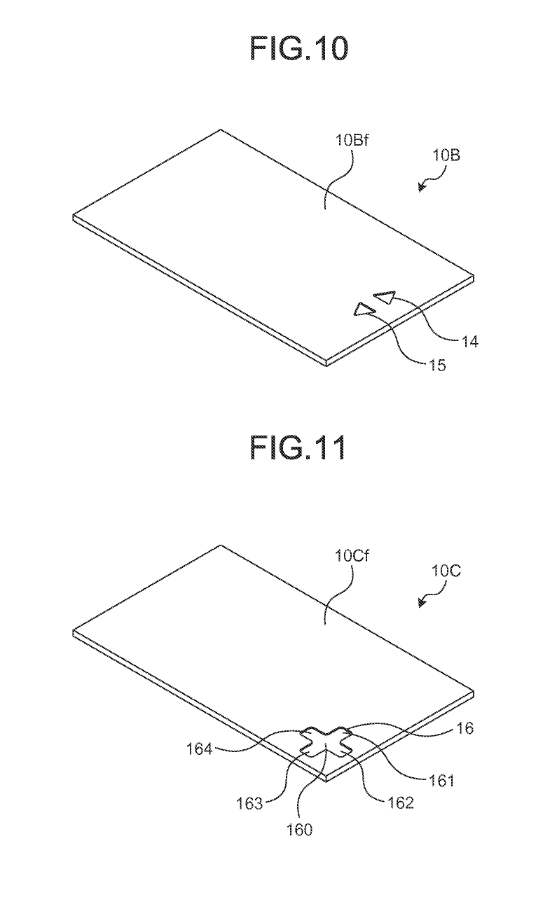

Although a modification of the embodiment 1 is described below, the modification is applicable to the embodiment 2 by replacing the recess portion with projection portion. FIG. 10 illustrates a schematic perspective view of a cover member according to the modification 1. The cover member 10B according to the modification 1 has recess portions 14, 15 on the side of the touch surface 10Bf which is opposed to a plane that faces the liquid crystal panel 30. As illustrated in FIG. 10, the recess portions 14, 15 have the same 2-dimensional shape and are oriented in a manner of a mirror image. Recess portions 14, 15 are located along and closer the traverse side of the touch surface 10Bf than the center thereof.

In the modification 1, the device controller 60 controls the audio component set that is external device in accordance with a change of the signal output from the output device 54. For example, when the user brings his/her finger into touch to the recess portion 14, the device controller 60 controls the audio component set to turn up a volume. When the user brings his/her finger into touch to the recess portion 15, the device controller 60 controls the audio component set to turn down the volume. The subject to be changed by the device controller 60, when the user brings his/her finger into touch to the recess portions 14, 15, is not limited to the volume of the audio component set.

Arrangement of the recess portions 14 and 15 are not limited thereto. For example, the recess portions 14, 15 may be located along a longitudinal side of the cover member 10B. Alternatively, the recess portions 14, 15 may be located at the center of the touch surface 10Bf. It is, however, preferable that the recess portions are located close to the longitudinal or traverse side away from the center of the touch surface 10Bf because the recess portions 14, 15 are less vivid. In addition to the recess portions 14, 15, the cover member 10B may include one of the recess portions 11, 12 and 13, or combination of a plurality of the recess portions 11, 12 and 13.

[Modification 2]

FIG. 11 illustrates a schematic perspective view of a cover member according to a modification 2. The cover member 10C according to the modification 2 has a recess portion 16 on the side of the touch surface 10Cf which is opposed to a plane that faces the liquid crystal panel 30. As illustrated in FIG. 11, the recess portion 16 has 2-dimensional cross shape and is positioned in a corner of the touch surface 10Cf. The recess portion 16 includes center portion 160 which is positioned at a center of the cross shape, an extended portion 161 which extends from the center portion 160 to one direction, an extended portion 162 which extends from the center portion 160 to a direction perpendicular to the extended portion 161, an extended portion 163 which extends from the center portion 160 to a direction opposite to the extend portion 161, and an extended portion 164 which extends from the center portion 160 to a direction opposite to the extend portion 162.

Arrangement of the recess portion 16 is not limited thereto. For example, the recess portion 16 may be located along a longitudinal side or a traverse side of the cover member 10C and at nearly middle point of the longitudinal side or the traverse side thereof. It is, however, preferable that the recess portion 16 is located close to the longitudinal or traverse side away from the center of the touch surface 10Cf because the recess portion 16 is less vivid. In addition to the recess portion 16, the cover member 10C may include one of the recess portions 11, 12, 13, 14 and 15 or combination of a plurality of the recess portions 11, 12, 13, 14 and 15.

In the modification 2, the device controller 60 controls the liquid crystal panel 30 in accordance with a signal from the output device 54. For example, when the user brings his/her finger into touch to the extended portion 161 of the recess portion 16, the device controller 60 controls the liquid crystal panel 30 to scroll the displayed image in the same direction as a direction in which the extended portion 161 extends from the center portion 160. When the user brings his/her finger into touch to the extended portion 162 of the recess portion 16, the device controller 60 controls the liquid crystal panel 30 to scroll the displayed image in the same direction as a direction in which the extended portion 162 extends from the center portion 160. When the user brings his/her finger into touch to the extended portion 163 of the recess portion 16, the device controller 60 controls the liquid crystal panel 30 to scroll the displayed image in the same direction as a direction in which the extended portion 163 extends from the center portion 160. When the user brings his/her finger into touch to the extended portion 164 of the recess portion 16, the device controller 60 controls the liquid crystal panel 30 to scroll the displayed image in the same direction as a direction in which the extended portion 164 extends from the center portion 160.

In the modification 2, the device controller 60 may control the audio component set which is an external device in accordance with a change of the signal output from the output device 54. For example, when the user brings his/her finger into touch to the extended portion 161 of the recess portion 16, the device controller 60 controls the audio component set to turn up a volume. When the user brings his/her finger into touch to the extended portion 163 of the recess portion 16, the device controller 60 controls the audio component set to turn down the volume. When the user brings his/her finger into touch to the extended portion 162 of the recess portion 16, the device controller 60 controls the audio component set to skip a tune forwardly. When the user brings his/her finger into touch to the extended portion 164 of the recess portion 16, the device controller 60 controls the audio component set to skip a tune backwardly. The subject to be changed by the device controller 60 when the user brings his/her finger touch into the recess portion 16 is not limited thereto.

In the modification 2, when a moving direction of a position where the touch detection device 40 has detected the change of electrostatic capacitance tracks the edge of the recess portion 16, the comparator 53 may change a signal output from the output device 54. For example, when the user moves his/her finger in a direction from either the extended portions 161, 162, 163 or 164 to another extended portion opposite to the extended portion, the device controller 60 controls the liquid crystal panel 30 to scroll the displayed image in the same direction.

[Modification 3]

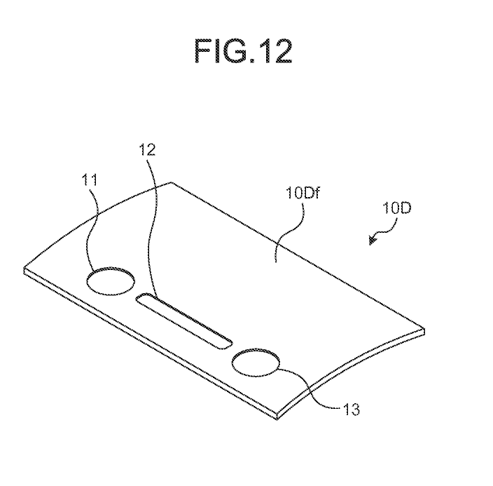

FIG. 12 illustrates a schematic perspective view of a cover member according to a modification 3. The cover member 10D according to the modification 3 has the recess portions 11, 12 and 13 on the side of the touch surface 10Df which is opposed to a plane that faces the liquid crystal panel 30. Furthermore, the touch surface 10Df is convex curve. In this way, because the touch surface 10Df is convex curve, the touch surface 10Df allows the user to easily recognize which position he/she is touching in entire the touch surface 10Df. Therefore, the user can easily recognize a position of the recess portions 11, 12, 13 on the display plane. Accordingly, the display device with touch detection function 1 enable the user to facilitate information input operation on the display plane even if the user cannot view the display plane. Alternatively, the touch surface 10Df may be concave curve.

### 2. APPLICATION EXAMPLE

### Electronic Apparatus

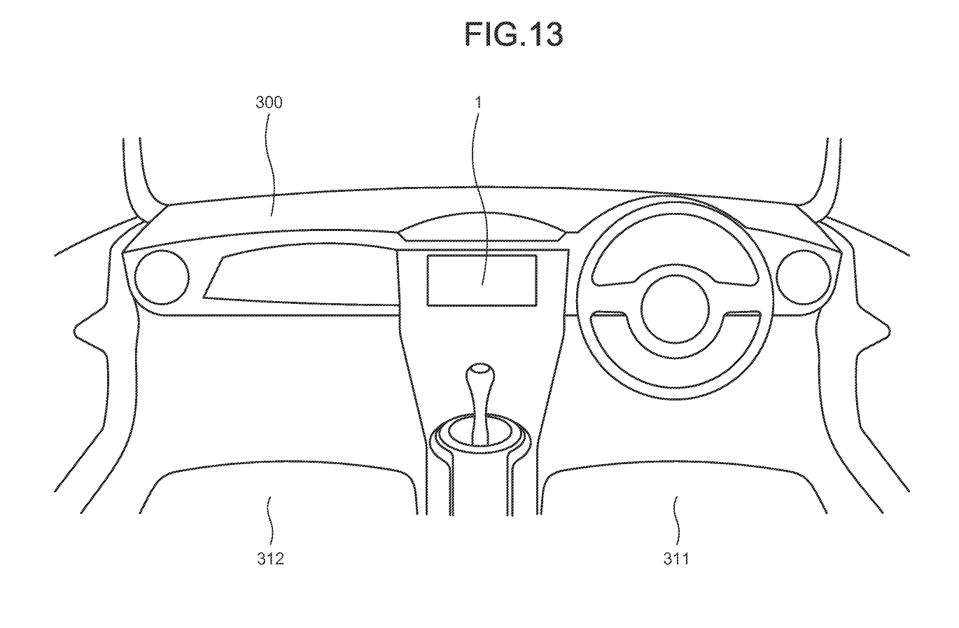

FIG. 13 illustrates an example of an electronic apparatus to which the display device with touch detection function according to the embodiments and modifications are applied. Aforementioned display device with touch detection function 1 according to the embodiments and modifications is applicable to the electronic apparatus in any field of art, for example, a vehicle navigation system, a television device, a portable terminal device such as digital camera, a laptop PC, a mobile phone, a video camera and so on. In other words, the display device with touch detection function 1 according to the embodiments and modifications is applicable to the electronic apparatus in any field of art, which displays still images or moving images produced with image signals that are input from an external device or image signals that are produced by itself internally. The electronic apparatus includes a control device that sends image signals to the liquid crystal panel 30 and controls the operation thereof.

In FIG. 13, the electronic apparatus is vehicle navigation system to which the display device with touch detection function 1 according to the embodiments and modifications is applied. The display device with touch detection function 1 is installed in a dashboard 300 in a car room. Specifically, the display device with touch detection function 1 is installed in the dashboard 300 at the position between a driver's seat 311 and an assistant driver's seat 312. The display device with touch detection function 1 of the vehicle navigation system is used as, for example, a display of navigation, a display of an operation panel of audio, a display of a movie, a display of a man to whom the user is talking over a phone, and so on. Preferably, aforementioned recess portions or projection portions on the touch surface 10f are located a side near to a driver's seat 311. This allows the user to facilitate information input operation because the user can easily reach the recess portions or projection portions of the display device with touch detection function 1.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

### 3. ASPECTS OF PRESENT DISCLOSURE

The present disclosure includes aspects as follows.

(1) A display device with touch detection functions comprising:

a display panel including a display plane for displaying images and an electrostatic capacitance type touch detection device;
a cover member stacked on the display plane of the display panel, the cover member having at least one recess portion and/or projection portion on the side of a touch surface opposite to a plane that faces the display panel; and
a controller configured to send a signal upon the touch detection device detects a variance of electrostatic capacitance proximity to the at least one recess portion and/or projection portion.

(2) The device according to (1), wherein the controller changes the signal in accordance with locus of a position where the touch detection device has detected variation of electrostatic capacitance.

(3) The device according to (1), wherein the touch surface is unti-glare treated.

(4) The device according to (1), wherein the touch surface is unti-reflection treated.

(5) The device according to (1), wherein the touch surface is treated with a water-shedding coating or an oil-shedding coating.

(6) The device according to (1), wherein the touch surface is treated with a hydrophilic coating or a lipophilic coating.

(7) The device according to (1) further comprising a buffer layer interposed between the display panel and the cover member, the buffer layer being made of optical elastic resin.

(8) The device according to (1) further comprising a transparent film overlapping a part of the touch surface, wherein side wall of the recess portion includes a cross-section of the transparent film.

(9) The device according to (1) further comprising a transparent film overlapping a part of the touch surface, wherein side wall of the projection portion includes a cross-section of the transparent film.

(10) The device according to (1), wherein the recess portion and/or projection portion has circular shape when viewed from a vertical direction relative to the touch surface.

(11) The device according to (1), wherein the recess portion and/or projection portion has rectangular shape when viewed from a vertical direction relative to the touch surface.

(12) The device according to (1), wherein the recess portion and/or projection portion has triangle shape when viewed from a vertical direction relative to the touch surface.

(13) The device according to (1), wherein the recess portion and/or projection portion has cross shape when viewed from a vertical direction relative to the touch surface.

(14) The device according to (1), wherein the touch surface is concave or convex curve.

(15) An electronic apparatus comprising:

a display panel including a display plane for displaying image and an electrostatic capacitance type touch detection device;
a cover member stacked on the display plane of the display panel, the cover member having at least one recess portion and/or projection portion on the side of a touch surface opposite to a plane that faces the display panel; and
a controller configured to send a signal upon the touch detection device detects a variance of electrostatic capacitance proximity to the at least one recess portion and/or projection portion.

(16) A cover member stacked on a display panel including an electrostatic capacitance type touch detection device and a display plane for displaying image, the cover member comprising at least one recess portion and/or projection portion on the side of a touch surface opposite to a plane that faces the display panel.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A display device with touch detection functions comprising:
a display panel including a display plane for displaying images and an electrostatic capacitance type touch detection device;
a cover member stacked on the display plane of the display panel, the cover member having at least one recess portion and/or projection portion on the side of a touch surface opposite to a plane that faces the display panel; and
a controller configured to send a signal upon the touch detection device detects a variance of electrostatic capacitance proximity to the at least one recess portion and/or projection portion.

2. The device set forth in claim 1, wherein the controller changes the signal in accordance with locus of a position where the touch detection device has detected variation of electrostatic capacitance.

3. The device set forth in claim 1, wherein the touch surface is unti-glare treated.

4. The device set forth in claim 1, wherein the touch surface is unti-reflection treated.

5. The device set forth in claim 1, wherein the touch surface is treated with a water-shedding coating or an oil-shedding coating.

6. The device set forth in claim 1, wherein the touch surface is treated with a hydrophilic coating or a lipophilic coating.

7. The device set forth in claim 1 further comprising a buffer layer interposed between the display panel and the cover member, the buffer layer being made of optical elastic resin.

8. The device set forth in claim 1 further comprising a transparent film overlapping a part of the touch surface, wherein side wall of the recess portion includes a cross-section of the transparent film.

9. The device set forth in claim 1 further comprising a transparent film overlapping a part of the touch surface, wherein side wall of the projection portion includes a cross-section of the transparent film.

10. The device set forth in claim 1, wherein the recess portion and/or projection portion has circular shape when viewed from a vertical direction relative to the touch surface.

11. The device set forth in claim 1, wherein the recess portion and/or projection portion has rectangular shape when viewed from a vertical direction relative to the touch surface.

12. The device set forth in claim 1, wherein the recess portion and/or projection portion has triangle shape when viewed from a vertical direction relative to the touch surface.

13. The device set forth in claim 1, wherein the recess portion and/or projection portion has cross shape when viewed from a vertical direction relative to the touch surface.

14. The device set forth in claim 1, wherein the touch surface is concave or convex curve.

15. An electronic apparatus comprising:
a display panel including a display plane for displaying image and electrostatic capacitance type touch detection device;
a cover member stacked on the display plane of the display panel, the cover member having at least one recess portion and/or projection portion on the side of a touch surface opposite to a plane that faces the display panel; and
a controller configured to send a signal upon the touch detection device detects a variance of electrostatic capacitance proximity to the at least one recess portion and/or projection portion.

16. A cover member stacked on a display panel that includes an electrostatic capacitance type touch detection device and a display plane for displaying image, the cover member comprising at least one recess portion and/or projection portion on the side of a touch surface opposite to a plane that faces the display panel.
